(19) United States
(12) Patent Application Publication
(10) Pub. No.: US 2017/0225070 A1
(43) Pub. Date: Aug. 10, 2017

(54) Interactive, inflatable play system

(71) Applicant: Viva Inflatables B.V., Steenwijk (NL)

(72) Inventor: Roland Baks, Steenwijk (NL)

(21) Appl. No.: 15/339,601

(22) Filed: Oct. 31, 2016

(30) Foreign Application Priority Data
Feb. 5, 2016 (DE) 202016100591

(51) Int. Cl. A63F 13/28; A63H 33/00; A63F 13/327; A63F 13/211; A63F 13/214

(52) U.S. Cl. CPC A63F 13/28; A63F 13/211; A63F 13/214; A63F 13/327; A63H 33/008; A63F 2250/05; A63F 2300/405

(57) ABSTRACT

An interactive, inflatable play system is based on an inflatable structure. A plurality of interaction modules is attached to the inflatable structure. Each interaction module comprises a touch sensor and a light source. An external control module in wireless is in bidirectional communication with the interaction modules. The external control module may comprises a counter and a display and may increment the counter in response to a wireless signal from the interaction modules indicating being touched by a user and displays a counter value.

### TECHNICAL FIELD

The present disclosure relates to an interactive, inflatable play system which includes at least one air cushion fillable with air, for example an inflatable jumper, air slide, or bounce house.

### BACKGROUND

Inflatable play systems, such as bounce houses, are generally known. Exemplary inflatable bounce houses are disclosed in US patent application publication 2009/0211,168 and U.S. Pat. No. 5,678,357, both of which are hereby incorporated by reference.

Inflatable play systems are popular attractions in outdoor game worlds, at swimming pools, at events, at campsites, etc., especially for use by children. Known inflatable play systems are characterized by the provision of different configurations in the form of inflatable jumpers, slides, water basins, labyrinth systems, tunnels, i.e., various shapes whereby interaction with these inflatable play systems consists of using these different forms, surfaces and areas of the inflatable play system by means of active physical exertion (climbing, jumping, running, crawling, etc.).

Known inflatable play systems are, however, not particularly interactive, leaving their use entirely up to the user without motivating any particular user actions. The inflatable play system known from U.S. Pat. No. 9,267,756 with an integrated projectile launcher provides some ability for the user to interact with the system beyond jumping, climbing or sliding thereon. But also the structure disclosed in U.S. Pat. No. 9,267,756 provides limited interaction between a user and the system, as no requirements are made on the use of the projectile launcher regarding active target objects or the like. U.S. Pat. No. 9,267,756 is hereby incorporated by reference.

### SUMMARY

The present disclosure describes an interactive, inflatable play system that permits active user interaction with the inflatable play system and/or its other users beyond mere bodily use, i.e. beyond just climbing, sliding, bouncing, and jumping thereon.

An inflatable play system which increases user interaction comprises a plurality of light and/or pressure and/or sound and/or temperature sensitive interaction modules that are provided on the inflatable play system, respectively on an inflatable air cushion thereof.

In a particularly advantageous embodiment at least one interaction module may be configured for outputting an optical, acoustic and/or haptic signal. At least one interaction module may be configured for the transmission of detected parameters to an external control unit and/or output and/or display device. The at least one interaction module is arranged on the inflatable play system. The at least one (active) interaction module may comprise a transmitter and/or receiver unit.

An interactive, inflatable play system may comprise an inflatable air cushion and at least one interaction module arranged on the inflatable air cushion. The interaction module may comprises a sensing element configured to sense light and/or pressure and/or sound and/or temperature. The interaction module may further comprise an output element configured to output an optical signal and/or an acoustic signal and/or a haptic signal. The interaction module may further comprise a transmitter and/or receiver unit.

An external control unit may be provided and at least one interaction module may comprise a transmitter. The interaction module may transmit to the external control module a parameter related to the sensed light and/or pressure and/or sound and/or temperature. In response, or independently thereof, that external control unit may control the output element of at least one interaction module.

A play system may comprise a plurality of interaction modules. The external control module may then activate the output elements of the interaction modules in a predetermined sequence, i.e. following a program, or randomly, based on a random number generator.

An interaction module or the external control module may determine the speed and/or the momentum and/or the acceleration of a user. The interaction module may also comprise sensors to detect the pulse and/or blood pressure and/or perspiration of a user. The interaction module may generate a sound and/or a voice and/or fragrance and/or a laser beam output.

A play system may comprise a first plurality of interaction modules and a second plurality of interaction modules. The first plurality of interaction modules may have a different color and/or shape than the second plurality of interaction modules.

An interactive, inflatable play system may comprise an inflatable structure and a plurality of interaction modules attached to the inflatable structure. Each interaction module may comprise a touch sensor and a light source. An external control module in wireless bidirectional communication with the interaction modules may be provided. The external control module may comprise a counter and a display. The counter may increase in response to a wireless signal from the interaction modules indicating being touched by a user. The display may show the counter value.

The following detailed description of the invention is merely exemplary in nature and is not intended to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 shows an inflatable play system in a preferred embodiment.

### DETAILED DESCRIPTION

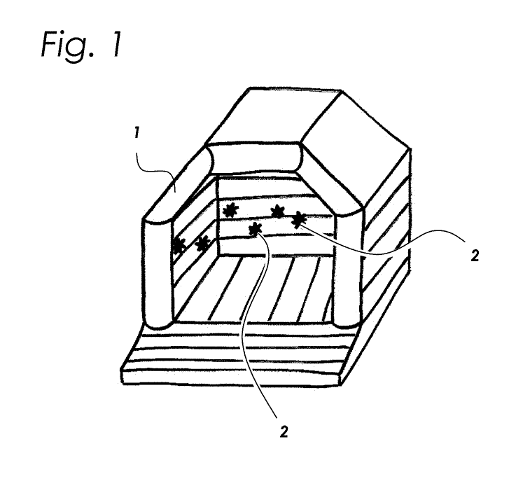

Shown in FIG. 1 is an interactive, inflatable play system 1. The play system 1 contains at least one inflatable air cushion, and a plurality of interaction modules 2 and/or interaction module areas surrounding the interaction modules 2 which are marked in color and/or by their shape (presently star-shaped).

The interaction module 2 may comprise an output element which may output light, sound, voice and/or fragrance and/or which may generate a laser beam, which further encourages interaction. The at least one interaction module 2 may be provided with LEDs or another suitable light source to output optical signals. The at least one interaction module 2 preferably has an integrated loudspeaker to output an acoustic signals.

The arrangement of several (active) interaction modules 2 on the inflatable play system allows beyond the normal bodily active interaction of the user(s) on the inflatable play system, wherein the responsiveness, speed and coordination of the user can additionally be supported by the switching of active interaction modules.

Thus, it is particularly advantageously provided that at least one control unit is provided for controlling the at least one active interaction module arranged on the inflatable play system for outputting one or more optical, acoustic and/or haptic signals. It would, for example, be possible to place an active interaction module 2 on the inflatable play system 1, which is activated by the control unit for outputting a signal, wherein it can be provided that a user reaches this interaction module 2 to actuate it as quickly as possible.

The control unit may also allow an interaction between a plurality of individual (active) interaction modules 2, preferably in such a way that the signaling of a plurality of interaction modules 2 is activated by the control unit depending on a program or a random generator. In this embodiment, a plurality of interaction modules 2 are placed on the inflatable play system 1 on different areas that are activated in a defined series or randomly so that one or more users must actuate these in the predefined series. A counting device may be provided in this case (by the program), which measures the number of actuations of the active interaction modules 2 by the respective user, wherein these then are output, for example, in the form of a score via an output and/or display device. Different skill games and even competitions can thus be held by means of the interactive inflatable play system 1.

The interaction modules 2 are advantageously equipped with at least one battery and transfer the data to be transmitted wirelessly, for example, via WiFi or Bluetooth. The interaction modules 2 on the inflatable play system 1 can also be connected by cables. The wireless variant, however, is particularly advantageous since it allows a subsequent attachment of the interaction modules 2 as well as the advantageously provided control unit on an ordinary inflatable play system.

In a further embodiment at least one interaction module 2 may be configured such that it determines the speed and/or the momentum and/or the acceleration of one or more users, which then, for example, are also output via an output and/or display device, and/or are evaluated in the control unit to determine and output additional control commands.

Also, it can be advantageous to additionally provide one or more interaction modules 2 for detecting the pulse, blood pressure, perspiration and/or chemical interaction modules 2 that are to be attached to the users and communicate with the control unit.

What is claimed is:

1. An interactive, inflatable play system, comprising:
an inflatable air cushion and
at least one interaction module arranged on the inflatable air cushion,
wherein the interaction module comprises a sensing element configured to sense light and/or pressure and/or sound and/or temperature.

2. The play system as in claim 1, wherein the at least one interaction module comprises a transmitter and/or receiver unit.

3. The play system as in claim 1, further comprising an external control unit, wherein the at least one interaction module comprises a transmitter and wherein the at least one interaction module transmits to the external control unit a parameter related to the sensed light and/or pressure and/or sound and/or temperature.

4. The play system as in claim 1, wherein the at least one interaction module comprises an output element configured to output an optical signal and/or an acoustic signal and/or a haptic signal.

5. The play system as in claim 4, further comprising an external control unit which communicates with the at least one interaction module, wherein the external control unit is configured to control the output element of the at least one interaction modules.

6. The play system as in claim 5 comprising a plurality of interaction modules, wherein the external control module activates the output elements of the plurality of interaction modules in a predetermined sequence or randomly.

7. The play system as in claim 1, wherein the at least one interaction module determines speed and/or momentum and/or acceleration of a user.

8. The play system as in claim 1, wherein the at least one interaction module detects the pulse and/or blood pressure and/or perspiration of a user.

9. The play system as in claim 1, wherein the interaction module generates a sound and/or a voice and/or fragrance output and/or a laser beam.

10. The play system as in claim 1, comprising a first plurality of interaction modules and a second plurality of interaction modules, wherein the first plurality of interaction modules have a different color and/or shape than the second plurality of interaction modules.

11. An interactive, inflatable play system, comprising:
an inflatable structure;
a plurality of interaction modules attached to the inflatable structure, wherein each interaction module comprises a touch sensor and a light source; and
an external control module in wireless bidirectional communication with the interaction modules.

12. The play system as in claim 11, wherein the external control module comprises a counter and a display and wherein the external module increments the counter in response to a wireless signal from the interaction modules indicating being touched by a user and wherein the external control module displays a counter value on the display.
